(19) United States
(12) Patent Application Publication
(10) Pub. No.: US 2019/0331249 A1
(43) Pub. Date: Oct. 31, 2019

(54) Proportional Normally-Open Valve with a Biasing Spring

(71) Applicant: Sun Hydraulics, LLC, Sarasota, FL (US)

(72) Inventor: Andy Borja, Sarasota, FL (US)

(21) Appl. No.: 15/962,116

(22) Filed: Apr. 25, 2018

(51) Int. Cl. F16K 31/06; F16K 17/04; F16K 1/44

(52) U.S. Cl. CPC F16K 31/0658; F16K 1/44; F16K 17/044

(57) ABSTRACT

An example valve includes: a sleeve; a first movable element disposed in the sleeve, where the first movable element is configured to move axially within the sleeve; a second movable element disposed, at least partially, in the first movable element, where the second movable element is configured to move axially within the first movable element; a first spring that interfaces with the second movable element and applies a force on the second movable element in a proximal direction; and an actuator including: a tube, a plunger disposed within the tube, a push pin disposed between the plunger and the second movable element, and a second spring disposed between the plunger and the tube, thereby biasing the plunger in a distal direction toward the push pin.

### BACKGROUND

A hydraulic valve directs the flow of a liquid medium, usually oil, through a hydraulic system. The direction of the oil flow is determined by the position of a movable element such as a spool or a poppet. An example valve may have the movable element inside a housing or sleeve. For instance, the valve may include a poppet that is movable by an actuation mechanism (e.g., electric, hydraulic, pneumatic, or manual). The valve may be a normally-open valve where the poppet is normally unseated and flow is allowed to flow from an inlet port to an outlet port. Once the valve is actuated, the poppet moves toward a seat formed inside the housing to restrict or block flow through the valve.

### SUMMARY

The present disclosure describes implementations that relate to a proportional normally-open valve with a biasing spring. In a first example implementation, the present disclosure describes a valve. The valve includes a main valve section including: (i) a housing, (ii) a sleeve disposed in the housing, (iii) a first poppet disposed in the sleeve and configured to move axially within the sleeve, (iv) a second poppet disposed, at least partially, in the first poppet, where the second poppet is configured to move axially within the first poppet, and (v) a first spring that interfaces with the second poppet and applies a force on the second poppet in a proximal direction. The valve also includes a push-type solenoid actuator including: (i) a solenoid tube disposed partially within the housing of the main valve section, (ii) an armature disposed within the solenoid tube, (iii) a push pin disposed between the armature and the second poppet, and (iv) a second spring disposed between the armature and the solenoid tube, thereby biasing the armature in a distal direction toward the push pin.

In a second example implementation, the present disclosure describes a valve. The valve includes: (i) a sleeve defining a first longitudinal cylindrical cavity therein; (ii) a first movable element disposed in the first longitudinal cylindrical cavity of the sleeve, where the first movable element is configured to move axially within the sleeve, and where the first movable element defines a second longitudinal cylindrical cavity therein; (iii) a second movable element disposed, at least partially, in the second longitudinal cylindrical cavity of the first movable element, where the second movable element is configured to move axially within the first movable element; (iv) a first spring that interfaces with the second movable element and applies a force on the second movable element in a proximal direction; and (v) an actuator including: (a) a tube, (b) a plunger disposed within the tube, (c) a push pin disposed between the plunger and the second movable element, and (d) a second spring disposed between the plunger and the tube, thereby biasing the plunger in a distal direction toward the push pin.

In a third example implementation, the present disclosure describes a hydraulic system. The hydraulic system includes: a source of pressurized fluid; a reservoir; and a valve. The valve includes: (i) a sleeve defining a first port fluidly coupled to the reservoir and a second port coupled to the source of pressurized fluid, (ii) a first poppet disposed in the sleeve and configured to move axially within the sleeve, where the sleeve defines a seat on an interior surface of the sleeve, where the valve is normally-open such that, when the valve is in an unactuated state, the first poppet is unseated off the seat and fluid flow is allowed from the second port to the first port, (iii) a second poppet disposed, at least partially, in the first poppet, where the second poppet is configured to move axially within the first poppet, (iv) a first spring that interfaces with the second poppet and applies a force on the second poppet in a proximal direction, and (v) a push-type solenoid actuator including: (a) a solenoid tube, (b) an armature disposed within the solenoid tube, (c) a push pin disposed between the armature and the second poppet, and (d) a second spring disposed between the armature and the solenoid tube, thereby biasing the armature in a distal direction toward the push pin.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

FIG. 1 illustrates a cross-sectional view of a valve that is normally-open, in accordance with an example implementation.

FIG. 2 illustrates a graph having a plot of variation of flow rate across the valve in FIG. 1 based on variation in commanded voltage to a solenoid coil of the valve, in accordance with an example implementation

FIG. 3 illustrates a cross-sectional view of a valve that is normally-open and having a spring configured to bias an armature in a distal direction, in accordance with an example implementation.

FIG. 4 illustrates a valve including springs, in accordance with another example implementation.

FIG. 5 illustrates a graph having a plot of variation of flow rate across the valve in FIG. 4 based on variation in commanded voltage to a solenoid coil of the valve, in accordance with an example implementation.

FIG. 6 illustrates a flowchart of a method of operating a valve, in accordance with an example implementation.

### DETAILED DESCRIPTION

In examples, a normally-open valve may have a poppet that is unseated off a seat formed as a protrusion from an interior surface of a cage, sleeve, valve body, or housing of the valve when the valve is unactuated. When the valve is in an unactuated state, fluid is allowed to flow from an inlet port through a gap or flow area formed between the poppet and the cage, sleeve, valve body, or housing of the valve to an outlet port. When the valve is actuated, the poppet is displaced toward the seat to restrict the gap or flow area and restrict flow through the valve. When the poppet is seated, fluid flow may be blocked. The valve may be a proportional valve where an axial position of the poppet affects the flow rate across the valve for a given pressure drop between the inlet port and the outlet port. In examples, the poppet may be displaced by an actuation force using an electric force applied by a solenoid, using hydraulic or pneumatic force, or by manual actuation.

The valve is configured such that, when the valve is unactuated, the poppet has a particular axial position such that the gap or flow area allows a particular amount of fluid flow. In examples, the valve may be oriented vertically where the poppet may be under gravitational force causing the poppet to move farther from the seat, thereby causing the flow rate across the valve when the valve is unactuated to increase to a flow rate that is larger than expected. In other examples, even if the valve is oriented horizontally, axial spaces, gaps, or slop may exist between different components of the valve, thereby causing the poppet to move farther from the seat, and causing the flow rate across the valve to be larger than expected. If a hydraulic system is configured to operate based on a particular maximum flow rate across the valve, then an increase in the maximum expected flow rate may be undesirable.

Thus, it may be desirable to configure the valve such that the components of the valve remain in contact with each other and the poppet maintains a particular axial position such that the maximum flow rate across the valve, when the valve is unactuated, is predictable and does not change abruptly during operation.

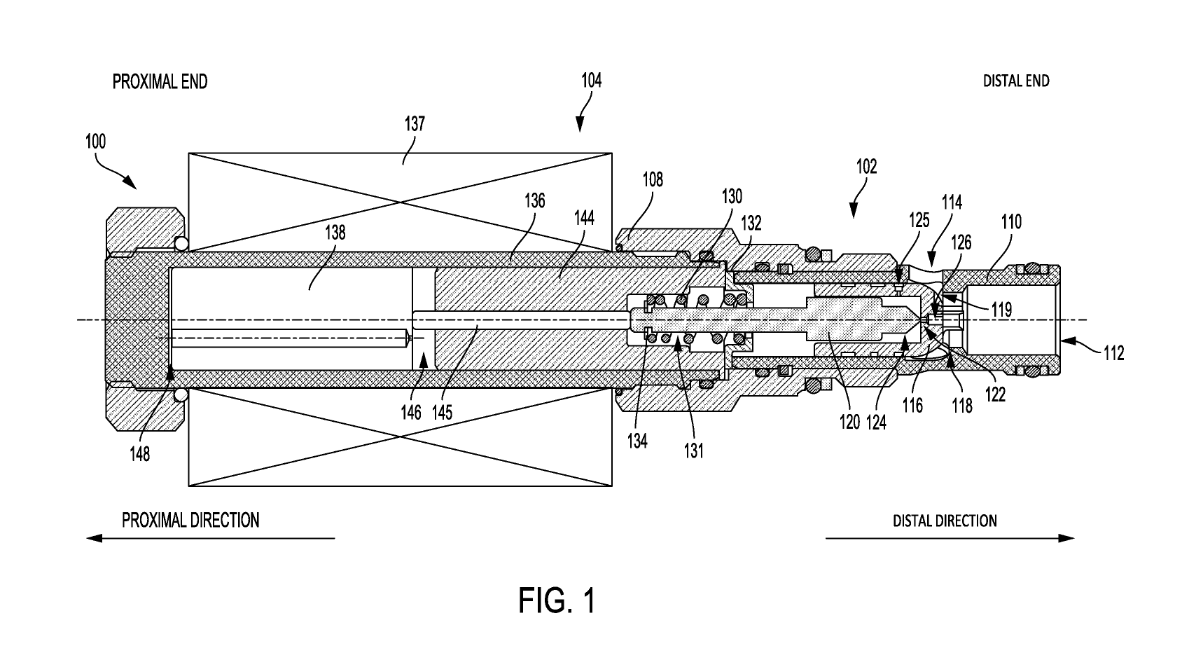

FIG. 1 illustrates a cross-sectional view of a valve 100 that is normally-open, in accordance with an example implementation. The valve 100 may include a main valve section 102 and a push-type solenoid actuator 104.

The main valve section 102 includes a housing 108 that defines a longitudinal cylindrical cavity therein. The longitudinal cylindrical cavity of the housing 108 is configured to receive at a distal end of a sleeve 110 disposed coaxially with the housing 108. The sleeve 110 defines a first port 112 and a second port 114. The first port 112 is defined at a nose of the sleeve 110, whereas the second port 114 may be defined as holes disposed in a radial array about an exterior surface of the sleeve 110. The valve 100 may be configured to control flow of fluid from the first port 112 to the second port 114 and from the second port 114 to the first port 112.

The sleeve 110 defines a respective longitudinal cylindrical cavity therein, and a first poppet 116 is disposed in the longitudinal cylindrical cavity defined within the sleeve 110, where the first poppet 116 is coaxial with the housing 108 and the sleeve 110. The first poppet 116 could also be referred to as a main or primary poppet.

The valve 100 is configured as a normally-open valve where in an unactuated state shown in FIG. 1, the first poppet 116 is unseated off a first seat 118 defined by an interior surface of the sleeve 110. In the unactuated state, a gap or flow area 119 is formed between the exterior surface of the first poppet 116 and the interior surface of the sleeve 110. With this configuration, the valve 100 can allow free flow from the second port 114 to the first port 112 through the flow area 119. As described below, the valve 100 can be actuated such that the first poppet 116 moves toward the first seat 118, and may be seated on the first seat 118 at a given actuation force. Particularly, the first poppet 116 has a tapered circumferential surface that contacts the first seat 118 when the first poppet 116 is seated thereon. In such actuated state, the first poppet 116 may block flow from the second port 114 to the first port 112.

The first poppet 116 defines a respective longitudinal cylindrical cavity therein. A second poppet 120 is disposed in the longitudinal cylindrical cavity defined within the first poppet 116. The second poppet 120 is coaxial with the housing 108, the sleeve 110, and the first poppet 116. The second poppet 120 may also be referred to as a dart or secondary poppet.

In the unactuated state of the valve 100 shown in FIG. 1, the second poppet 120 is positioned within a particular distance (e.g., 0.006 inches) from a second seat 122 defined by an interior surface of the first poppet 116. As such, a donut-shaped orifice is formed between the second poppet 120 and the first poppet 116, which allows for the first poppet 116 to be hydraulically balanced and maintain its position, thereby maintaining the flow area 119. Further, a chamber 124 is defined within the first poppet 116 between an exterior surface of the second poppet 120 and the interior surface of the first poppet 116. During operation of the valve 100, pressurized fluid received at the second port 114 is communicated through a pilot feed orifice 125 disposed in the first poppet 116 to the chamber 124.

The valve 100 further includes a longitudinal passage or longitudinal channel 126 defined in a distal end of the first poppet 116. If the second poppet 120 moves in the proximal direction, fluid may flow from the chamber 124 through the longitudinal channel 126 to the first port 112.

The valve 100 further includes a spring 130 disposed in a chamber 131 defined within the housing 108. The spring 130 is disposed around the exterior surface of the second poppet 120 and is disposed axially between: (i) a spring support member 132 that is ring-shaped and disposed in the longitudinal cylindrical cavity of the housing 108, and (ii) a washer or retaining ring 134 disposed in a groove defined in the exterior surface of the second poppet 120. If the spring 130 is compressed, the spring 130 applies a force on the retaining ring 134 and the second poppet 120 in a proximal direction (e.g., to the left in FIG. 1).

The push-type solenoid actuator 104 includes a solenoid tube 136 disposed within and received at a proximal end of the housing 108, such that the solenoid tube 136 is coaxial with the housing 108. A solenoid coil 137 may be disposed about an exterior surface of the solenoid tube 136.

The solenoid tube 136 is configured to house a plunger or armature 138. The solenoid tube 136 houses a pole piece 144 coaxial with the armature 138 and the solenoid tube 136.

The pole piece 144 further defines a longitudinal channel therein, and a push pin 145 is disposed in the longitudinal channel of the pole piece 144 between the second poppet 120 and the armature 138. Further, the pole piece 144 is separated from the armature 138 by an airgap 146 traversed by the push pin 145, and the push pin 145 is configured to interface with the armature 138. The pole piece 144 is composed of material of high magnetic permeability.

When an electric current is provided through the windings of the solenoid coil 137, a magnetic field is generated. The pole piece 144 directs the magnetic field through the airgap 146 toward the armature 138, which is movable and is attracted toward the pole piece 144. In other words, when an electric current is applied to the solenoid coil 137, the generated magnetic field forms a north and south pole in the pole piece 144 and the armature 138, and therefore the pole piece 144 and the armature 138 are attracted to each other. Because the pole piece 144 is fixed while the armature 138 is movable, the armature 138 is attracted and is movable across the airgap 146 toward the pole piece 144. Thus, when the electric current or voltage is provided to the solenoid coil 137, a solenoid force is generated and is applied to the armature 138, thereby attracting the armature 138 toward the pole piece 144.

As the armature 138 is attracted toward the push pin 145, the armature 138 applies a force on the push pin 145. The armature 138 thus pushes the push pin 145 in the distal direction (e.g., to the right in FIG. 1), and may cause the push pin 145 to move axially in the distal direction, thereby contacting a proximal end of the second poppet 120. When the solenoid force overcomes a force of the spring 130 and friction forces, the push pin 145 can cause the second poppet 120 to also move axially in the distal direction. The second poppet 120 can then be seated at the second seat 122 and can thus contact the first poppet 116. The second poppet 120 then pushes the first poppet 116 in the distal direction toward the first seat 118. The axial distance that the armature 138, the push pin 145, the second poppet 120, and the first poppet 116 move is based on a magnitude of electric signal (e.g., electric current) provided to the solenoid coil 137 (i.e., based on a magnitude of the solenoid force generated by the electric signal).

As the first poppet 116 moves toward the first seat 118, the flow area 119 defined between the interior surface of the sleeve 110 and the exterior surface of the first poppet 116 is restricted. In an example, the magnitude of the electric signal might be such that the first poppet 116 moves toward the first seat 118, but is not seated at the first seat 118. In other words, the first poppet 116 stops mid-stroke between the position shown in FIG. 1 and a fully seated position at which the first poppet 116 is seated at the first seat 118. In this example, if fluid is flowing from the second port 114 to the first port 112, then restricting the flow area 119 between the interior surface of the sleeve 110 and the exterior surface of the first poppet 116 causes a volume of fluid (e.g., flow rate across the flow area 119) to decrease as the first poppet 116 approaches the first seat 118. The decrease in volume of fluid or flow rate across the flow area 119 is based on the magnitude of the electric signal to the solenoid coil 137 of the push-type solenoid actuator 104 because the magnitude of the electric signal determines the axial position of the first poppet 116 within the longitudinal cylindrical cavity of the sleeve 110. Further, if the magnitude of the electric signal is sufficient to cause the first poppet 116 to be seated at the first seat 118, fluid received at the second port 114 is blocked from flowing to the first port 112.

When the solenoid coil 137 is de-energized (e.g., command signal to the solenoid coil 137 is reduced or removed), the armature 138 is no longer attracted by a magnetic force toward the pole piece 144, and the spring 130 pushes the second poppet 120 in the proximal direction. As a result, fluid in the chamber 124 is allowed to flow through the longitudinal channel 126 to the first port 112. The first port 112 may be fluidly coupled to a low pressure reservoir or tank. Thus, the pressure level in the chamber 124 is reduced as the fluid is vented from the chamber 124 through the first port 112 to the tank.

Further, the fluid received at the second port 114 applies a force on a tapered exterior surface of a nose or distal end of the first poppet 116. Because of the difference in pressure level between the fluid received at the second port 114 and the fluid in the chamber 124, the first poppet 116 is moved axially in the proximal direction (e.g., to the left in FIG. 1) and is unseated off the first seat 118. The first poppet 116 thus follows the second poppet 120 in the proximal direction until the second poppet 120 stops. At this position, the first poppet 116 also stops and maintains a particular distance (e.g., 0.006 inches) between the second poppet 120 and the second seat 122. In this position, the valve 100 is reopened and fluid is allowed to flow from the second port 114 to the first port 112.

The valve 100 may be configured such that, when the valve 100 is unactuated, the first poppet 116 has a particular axial position within the sleeve 110 such that the flow area 119 allows a particular amount of fluid flow therethrough. In an example, the valve 100 may be installed on a machine such that the valve 100 is oriented vertically. For instance, the distal end of the valve 100 (e.g., the first port 112) may be pointed upward, whereas the proximal end of the valve 100 may be pointed downward. In this orientation, the components of the valve 100 including the first poppet 116 and the second poppet 120 are subjected to downward gravitational force. Whether by design or due to manufacturing tolerance issues, axial gaps or spaces may exist between the different components of the valve 100. As an example, a gap 148 may separate the proximal end of the armature 138 from an interior proximal surface of the solenoid tube 136. Thus, the gravitational forces may cause the first poppet 116 to move farther from the first seat 118 when the valve 100 is unactuated. As a result, the flow area 119 increases in size, and the flow rate across the valve 100 when the valve 100 is unactuated may increase to a flow rate that is larger than expected.

In other examples, even if the valve 100 is oriented horizontally, when pressurized fluid is communicated to the second port 114, the pressurized fluid applies a force on the first poppet 116 in the proximal direction. If any axial spaces exists (e.g., the gap 148) between the different components of the valve 100, the first poppet 116 may be pushed in the proximal direction farther from the first seat 118, thereby causing the flow area 119 and the flow rate across the valve 100 to be larger than expected.

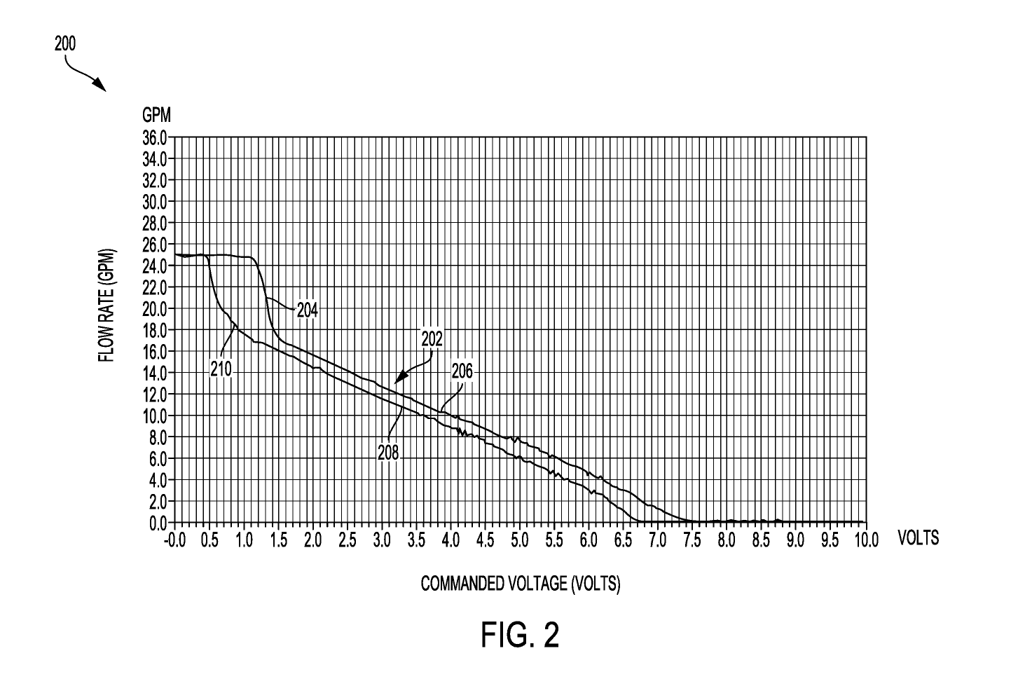

FIG. 2 illustrates a graph 200 having a plot 202 of variation of flow rate across the valve 100 based on variation in commanded voltage to the solenoid coil 137, in accordance with an example implementation. Commanded voltage is shown in Volts on the x-axis of the graph 200, and flow rate of fluid flow across the valve 100 is shown on the y-axis of the graph 200 in gallons per minute (GPM).

As depicted in FIG. 2, when the valve 100 is unactuated (i.e., the commanded voltage is zero Volts) a large amount of flow rate of about 24.5 GPM flows from the second port 114 to the first port 112. Such flow rate may be larger than what is expected from the valve 100 due to the first poppet 116 being placed farther from the first seat 118 and the flow area 119 being larger than expected. As commanded voltage is increased gradually, the flow rate across the valve 100 remains substantially the same until the commanded voltage reaches about 1.1 Volts. Between the 1.1 Volts commanded voltage and a commanded voltage of about 1.4 volts, a large abrupt drop in flow rate shown by a portion 204 of the plot 202 occurs, and the flow rate is reduced to about 17 GPM. Such abrupt drop in flow rate may indicate that as the solenoid coil 137 is energized and the armature 138 moves in the distal direction, the components of the valve 100 contact each other axially, alleviating any axial gaps therebetween (e.g., the armature 138 contacts the push pin 145 and the push pin 145 contacts the second poppet 120). As a result, the second poppet 120 and the first poppet 116 may move abruptly to an axial position closer to the first seat 118, thereby restricting the flow area 119 causing the large drop in flow rate depicted by the portion 204.

Thereafter, a portion 206 of the plot 202 indicates proportional decrease in the flow rate as the commanded voltage is increased until a value of about 7.5 Volts, at which value the first poppet 116 is seated at the first seat 118, and fluid flow across the valve 100 is blocked. Increasing the commanded voltage from 7.5 Volts to 10 volts does not substantially change flow characteristics of the valve 100 as depicted in FIG. 2, where fluid flow rate remains blocked. The commanded voltage is then reduced gradually from the value of 10 Volts to zero Volts, and the corresponding variation in flow rate is depicted by portion 208 of the plot 202. At a commanded voltage value of about 6.7 Volts, the second poppet 120 moves in the proximal direction, and the first poppet 116 follows the second poppet 120 in the axial direction moving off the first seat 118. As such, flow rate starts to increase gradually along with the gradual change in commanded voltage. The flow rate is again abruptly increased as commanded voltage is decreased from about 0.9 volts to zero volts as indicated by portion 210 of the plot 202.

The abrupt increase in flow rate as depicted by the portion 204 of the plot 202 may be undesirable. If a hydraulic system is configured to operate based on a particular maximum flow rate across the valve 100, then an increase in the maximum flow rate may be undesirable. Thus, it may be desirable to configure the valve 100 such that the components of the valve 100 remain in contact with each other such that the first poppet 116 substantially maintains a particular axial position within the sleeve 110 when the valve 100 is unactuated. This way the maximum flow rate across the valve 100, when the valve 100 is unactuated, is predictable.

As an example, when the valve 100 is unactuated, it may be desirable to maintain the second poppet 120 at a particular axial position determined by an uncompressed length of the spring 130. In the unactuated state of the valve 100, the second poppet 120 is seated on the first poppet 116, and thus the axial position of the first poppet 116 is interrelated with the axial position of the second poppet 120. As such, positioning the second poppet 120 at a particular axial position, as determined by the uncompressed length of the spring 130, causes the first poppet 116 to be positioned at a corresponding axial position.

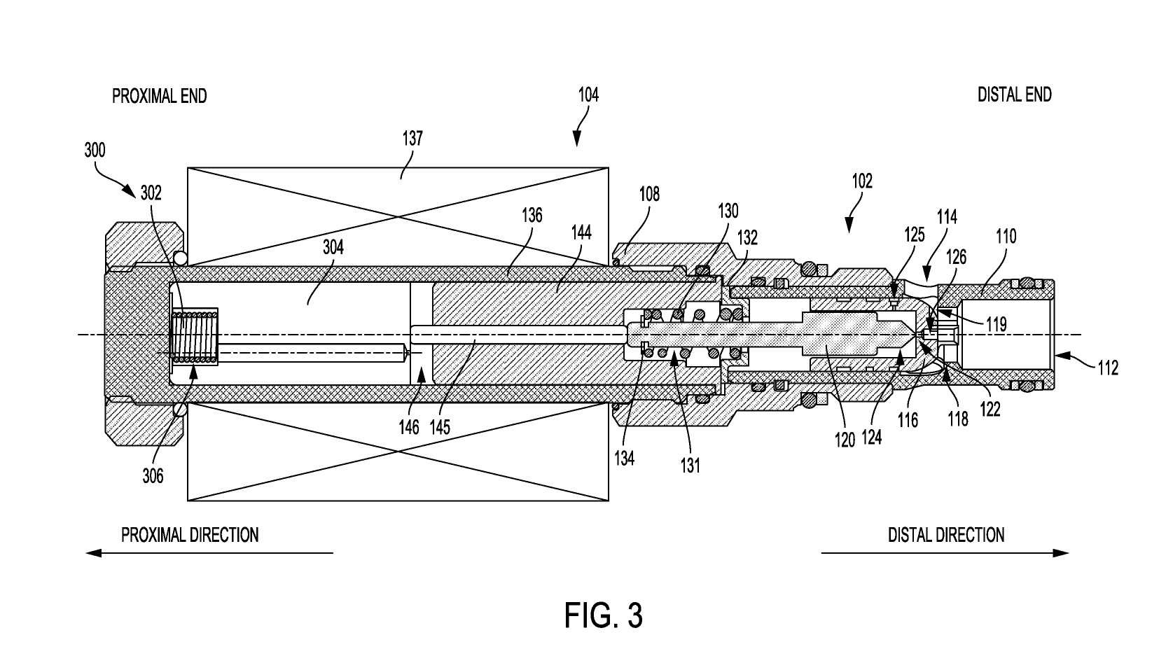

FIG. 3 illustrates a cross-sectional view of a valve 300 that is normally-open and having a spring 302 configured to bias an armature 304 in the distal direction, in accordance with an example implementation. Similar components between the valve 100 and the valve 300 are designated with the same reference numbers. The armature 138 of the valve 100 is replaced by the armature 304. The armature 304 differs from the armature 138 in that the armature 304 includes a cavity 306 formed as a blind hole or pocket at a proximal end of the armature 304. The cavity 306 houses the spring 302.

A proximal end of the spring 302 rests against and interfaces with the interior proximal surface of the solenoid tube 136. A distal end of the spring 302 rests against an interior surface of the armature 304 that forms a distal end of the cavity 306. Because the solenoid tube 136 is fixed, the spring 302 applies a force on and biases the armature 304 in the distal direction. When the valve 300 is unactuated, the spring 302 biases the armature 304 in the distal direction causing the armature 304 to maintain contact with the push pin 145, and thereby causing the push pin 145 to maintain contact with the second poppet 120. The second poppet 120 in turn maintains the axial position of the first poppet 116 within the sleeve 110.

As such, the spring 302 can alleviate axial spaces, gaps, or slop between the armature 304, the push pin 145, the second poppet 120 and the first poppet 116, and can thus cause the first poppet 116 to substantially maintain a particular axial position. The particular axial position causes the flow area 119 to allow a particular and predictable amount of flow to pass therethrough for a particular pressure drop between the second port 114 and the first port 112. The term “substantially” is used, for example, to indicate that the axial position of the first poppet 116 or the flow area 119 is equal to or within a threshold position or area value (e.g., ±1-5% from a threshold value). In addition, by the term “substantially” used above and throughout the description herein, it is meant that the recited characteristic, parameter, measurement, or value need not be achieved exactly, but that deviations or variations, including for example, tolerances, measurement error, measurement accuracy limitations, manufacturing deviations, and other factors known to skill in the art, may occur in amounts that do not preclude the effect the characteristic was intended to provide.

Further, the spring 302 is configured as a “light” spring such that the spring 302 applies a small force that does not exceed a predetermined value on the spring 130 in the distal direction. This way, the spring 302 does not substantially compress the spring 130, and thus a magnitude of force that the spring 130 applies to the second poppet 120 in the proximal direction via the retaining ring 134 is not substantially changed. As a result, presence of the spring 302 might not substantially change flow characteristics (e.g., the flow rate from the second port 114 to the first port 112 at a given pressure drop therebetween) of the valve 300.

As an example, the spring 302 may have a spring rate that is two orders of magnitude lower than a spring rate of the spring 130. As an example for illustration, the spring 302 may have a spring rate of 2 pound-force per inch (lbf/in), whereas the spring 130 may have a spring rate of 260 lbf/in.

Although the spring 302 is shown in FIG. 3 to be disposed in the cavity 306 formed in the armature 304, in other example implementations the spring 302 could be disposed in a cavity formed in the proximal end of the solenoid tube 136 and interface with the armature 304 to bias the armature 304 in the distal direction. In another example, the spring 302 could be disposed partially in a cavity formed in the solenoid tube 136 and partially in a cavity formed in the armature 304.

In another example, rather than using the spring 302, which is a compression spring configured to push the armature 304 in the distal direction, a tension or extension spring could be used to pull the armature 304 in the distal direction. For instance, a distal end of such an extension spring can be coupled to the pole piece 144 or another fixed component of the valve 300, whereas a proximal end of the extension spring can be coupled to the armature 304. With this configuration, the extension spring may pull the armature 304 toward the pole piece 144, thereby causing the armature 304, the push pin 145, the second poppet 120, and the first poppet 116 to remain in contact with each other when the valve 300 is unactuated.

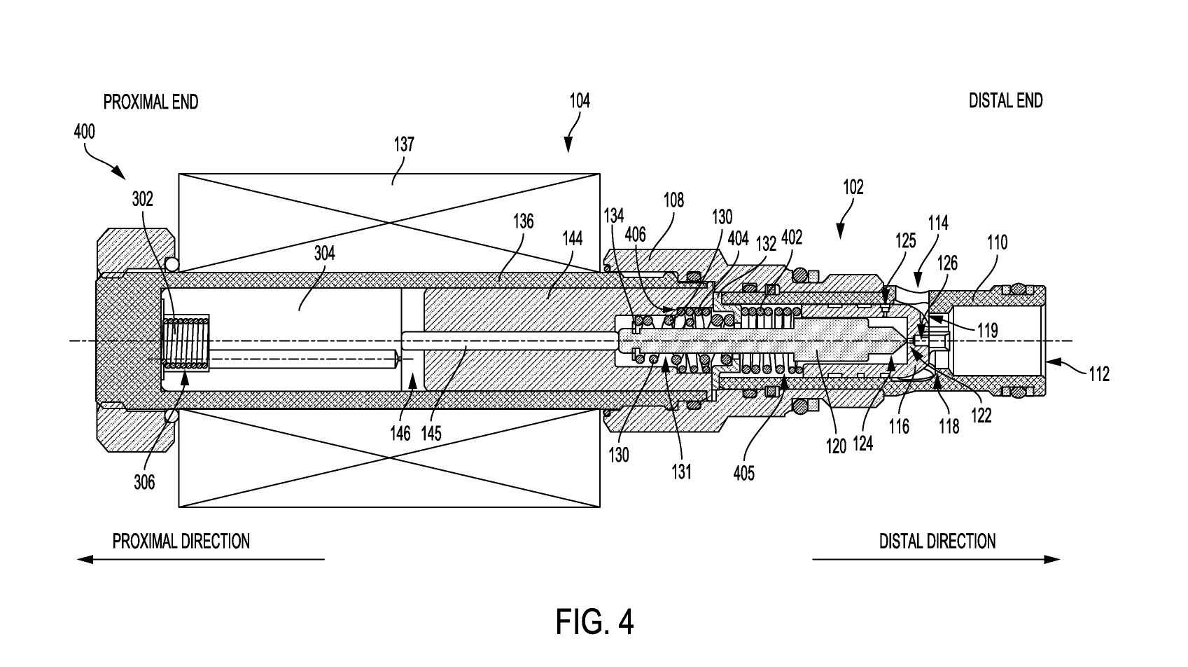

Additionally or alternatively, other springs or biasing members can be added to the valve 300 to cause the components of the valve 300 to maintain axial contact. FIG. 4 illustrate a valve 400 including springs 402 and 404, in accordance with an example implementation. The valve 400 is similar to the valve 300, but includes the springs 402 and 404 in addition to the spring 302. Similar components between the valve 100, the valve 300, and the valve 400 are designated with the same reference numbers.

The spring 402 is disposed about the exterior surface of the second poppet 120 between the proximal end of the first poppet 116 and the spring support member 132. The spring 402 is thus disposed in a chamber 405 formed within the housing 108 and the sleeve 110, where the chamber 405 is bounded by proximal end of the first poppet 116, the spring support member 132, and the exterior surface of the second poppet 120. The spring 402 is configured to bias the first poppet 116 in the distal direction, causing the first poppet 116 to be maintained at a particular axial position. For example, if the valve 400 is oriented vertically with the first port 112 pointing upward, the spring 402 biases the first poppet 116 to the particular axial position when the valve 400 is unactuated. As such, gravitational forces on the first poppet 116 might not cause the flow area 119 to increase.

In examples, due to manufacturing tolerances or for ease of assembly, the spring support member 132 may be floating as opposed to being fixed or stationary. As such, the spring support member 132 might be allowed to move axially in the axial space between the proximal end of the sleeve 110 and the distal end of the pole piece 144. In these examples, the spring 402 might bias the spring support member 132 in the proximal direction. The spring support member 132 in turn might apply a force on the spring 130 in the proximal direction, thus applying a force on the second poppet 120 via the retaining ring 134 in the proximal direction.

Such force that might be applied to the second poppet 120 by the spring 402 may cause the flow area 119 and the maximum flow rate through the valve 400 to increase when the valve 400 is unactuated. For instance, pushing the spring 130 in the proximal direction via the spring support member 132 may compress the spring 130 and cause the force that the spring 130 applies to the second poppet 120 via the retaining ring 134 to change. As a result, the force that the armature 304 needs to overcome to push the second poppet 120 in the distal direction changes, and the flow characteristics of the valve 400 might change (e.g., the flow rate at a particular commanded voltage to the solenoid coil 137 for a particular pressure drop from the second port 114 to the first port 112 might change). Additionally, the force applied to the spring 130 in the proximal direction via the spring 402 and the spring support member 132 may cause the spring 130 to move the second poppet 120 in the proximal direction, and the first poppet 116 may also move to follow the second poppet 120 if there is pressurized fluid at the second port 114. As a result, the flow area 119 and the maximum flow capacity of the valve 400 can increase when the valve 400 is unactuated.

In the example where the spring support member 132 is floating or axially movable and the spring 402 may cause the spring support member 132 to be biased in the proximal direction, the spring 404 is disposed in the valve 400 to counteract the force applied by the spring 402 on the spring support member 132. Particularly, the spring 404 is disposed about the spring 130 between the proximal end of the spring support member 132 and a shoulder 406 formed on an interior surface of the pole piece 144. Because the pole piece 144 is fixed, the spring 404 applies a force on the spring support member 132 in the distal direction, thus counteracting the force of the spring 402 on the spring support member 132 in the proximal direction.

In an example, the spring 404 may have a larger spring rate (e.g., an order of magnitude larger) compared to a spring rate of the spring 402. As an example for illustration only, the spring rate of the spring 402 can be about 3 lbf/in, whereas the spring rate of the spring 404 can be about 42 lbf/in. Thus, the spring 404 can apply a larger force in the distal direction on the spring support member 132 compared to the force that the spring 402 applies on the spring support member 132 in the proximal direction. As such, the spring 404 causes the distal end of the spring 130 to be held in place via the spring support member 132. The spring 402 then biases the first poppet 116 in the distal direction without affecting operation of the spring 130 or altering the maximum flow capacity of the valve 400.

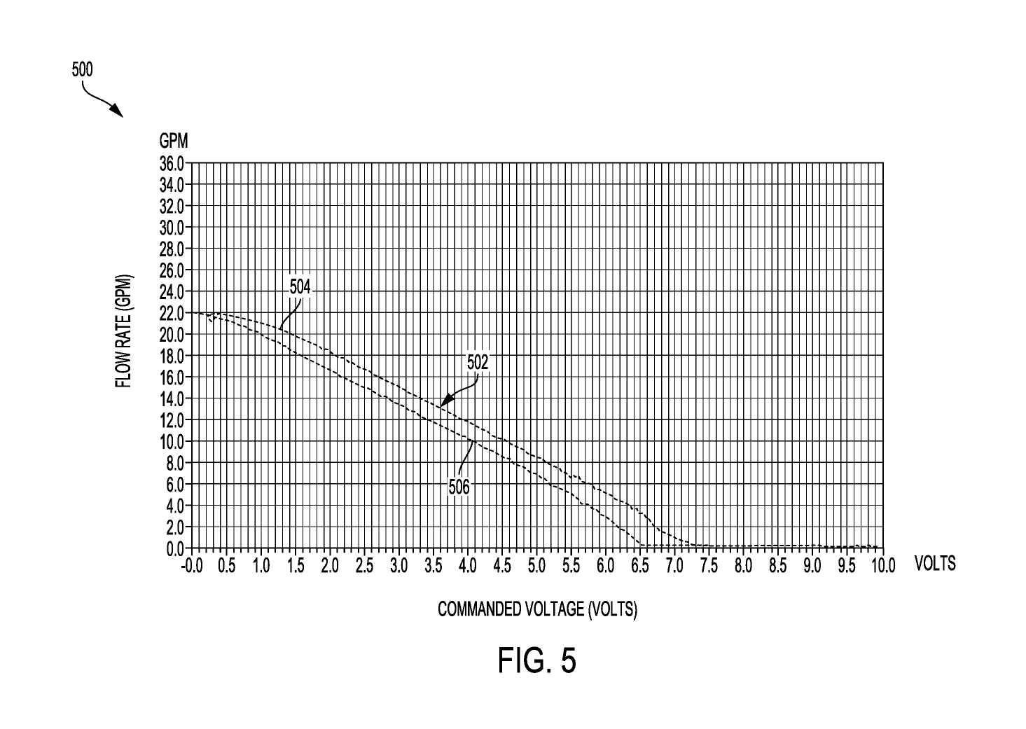

FIG. 5 illustrates a graph 500 having a plot 502 of variation of flow rate across the valve 400 based on variation in commanded voltage to the solenoid coil 137, in accordance with an example implementation. Commanded voltage is shown in Volts on the x-axis of the graph 500, and flow rate of fluid flow across the valve 400 is shown on the y-axis of the graph 500 in GPM.

As depicted in FIG. 5, when commanded voltage to the solenoid coil 137 of the valve 400 is zero volts, maximum flow across the valve 400 from the second port 114 to the first port 112 is about 22 GPM. As commanded voltage is increased gradually, the solenoid force is applied to the armature 304, which then transfers the solenoid force on the push pin 145 in the distal direction. The push pin 145 in turn applies a force on the second poppet 120, and the second poppet 120 applies a force on the first poppet 116. When the solenoid force overcomes the force of the spring 130 and friction forces in the valve 400, the armature 138 moves in the distal direction. As a result, the push pin 145, the second poppet 120, and the first poppet 116 move therewith. Thus, the first poppet 116 moves axially in the distal direction toward the first seat 118, thereby restricting fluid flow across the valve 400.

The presence of the spring 302, the spring 402, and the spring 404 alleviates gaps between the components (e.g., the armature 138, the push pin 145, and the second poppet 120) of the valve 400 and causes the components to maintain contact with each other during operation of the valve 400. As a result, the first poppet 116 may maintain a predetermined axial position relative to the first seat 118. Thus, the flow rate across the valve 400 when the valve 400 is unactuated (e.g., when the commanded voltage is zero volts) can be predictable and might not exceed a predetermined flow rate.

Further, when the valve 400 is actuated (e.g., as commanded voltage is increased), as depicted in FIG. 5, there is no abrupt change in the flow rate that corresponds to the portion 204 of the plot 202 in FIG. 2. Rather, a portion 504 of the plot 502 indicates smooth (gradual) proportional decrease or reduction in the flow rate as the commanded voltage is increased until a value of about 7.3 volts, at which the flow rate is substantially zero as the first poppet 116 is seated the first seat 118. Increasing the commanded voltage to 10 volts might not affect the flow rate across the valve 400. When the commanded voltage is then reduced gradually from the value of about 10 volts to zero volts, the corresponding variation in flow rate is depicted by portion 506 of the plot 502. As depicted in FIG. 5, there is no abrupt change in the flow rate that corresponds to the portion 210 of the plot 202 in FIG. 2.

As such, the presence of the spring 302, the spring 402, and the spring 404 may substantially preclude abrupt changes in the flow rate across the valve 400 as the solenoid coil 137 is energized or as the solenoid coil 137 is de-energized. As a result, an actuator or any other hydraulic component controlled by the valve 400 might not experience an abrupt increase or decrease in the flow rate of fluid provided thereto.

The configurations and components shown in FIGS. 1 and 3-4 are examples for illustration, and different configurations and components could be used. For example, different types of springs and biasing members could be used. Further, rather than the push-type solenoid actuator 104, a manual or other actuation mechanism could be used. As such, any type of actuator having a plunger can be used. The plunger can be configured to operate similar to the armature 138 or 304 and can interface with push pin 145 to apply a force thereto. The plunger may be movable or actuatable manually via a lever or knob coupled thereto, or via a hydraulic or pneumatic pressure applied thereto. The spring 302 biases such plunger toward the push pin 145 so as to alleviate gaps between components of the valve. The springs 402 and 404 could be used as described above with respect to FIG. 4.

In example implementations, several components may be integrated into a single component rather than having separate components. In an example, rather than using the retaining ring 134 disposed in a groove of the second poppet 120, the second poppet 120 may include a flanged portion projecting from and integral with the exterior surface of the second poppet 120.

Further, although the valves 100, 300, and 400 are shown as valves including poppets, the configuration of the spring 302, the spring 402, and the spring 404 can also be implemented for other valve configurations involving a spool to preclude abrupt change in flow rate across the spool.

As such, the description above with respect to operation of the valves 300 and 400 can be applied to any valve having: a sleeve (e.g., the sleeve 110); a first movable element (e.g., the first poppet 116) disposed in the sleeve, where the first movable element is configured to move axially within the sleeve; a second movable element (e.g., the second poppet 120) disposed, at least partially, in the first movable element, where the second movable element is configured to be seated on a seat (e.g., the second seat 122) defined on an interior surface of the first movable element, and where the second movable element is configured to move axially within the first movable element; a first spring (e.g., the spring 130) that interfaces with the second movable element and applies a first force on the second movable element in a proximal direction; and an actuator that includes comprising: (i) a tube (e.g., the solenoid tube 136), (ii) a plunger (e.g., the armature 304) disposed within the tube, (iii) a push pin (e.g., the push pin 145) disposed between the plunger and the second movable element, and (iv) a second spring eg., the spring 302) disposed between the plunger and the tube, thereby biasing the plunger in a distal direction toward the push pin.

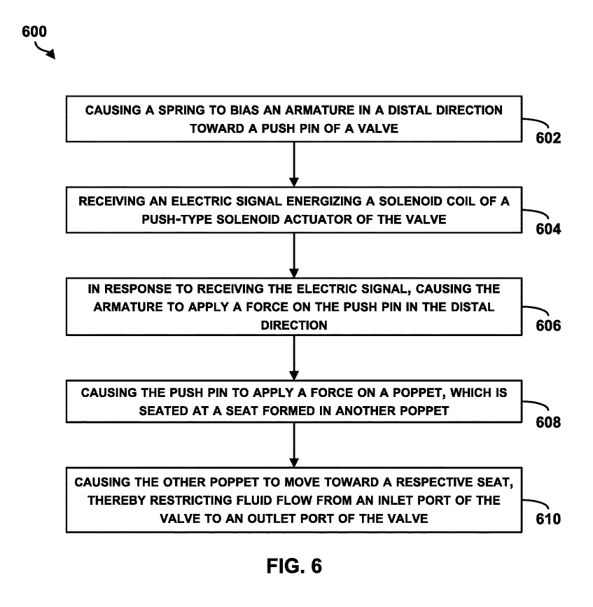

FIG. 6 illustrates a flowchart of a method 600 of operating a valve, in accordance with an example implementation. The method 600 shown in FIG. 6 presents an example of a method that could be used with the valve 300 or the valve 400 described above and shown in FIGS. 3-4, for example. The method 600 may include one or more operations, functions, or actions as illustrated by one or more of blocks 602-610. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 602, the method 600 includes causing the spring 302 to bias the armature 304 in a distal direction toward the push pin 145 of the valve 300 or the valve 400.

At block 604, the method 600 includes receiving an electric signal energizing the solenoid coil 137 of the push-type solenoid actuator 104 of the valve 300 or the valve 400.

A controller of a hydraulic system or hydraulic circuit that includes the valve 300 or the valve 400 may receive a request to actuate the valve 300 or the valve 400, which is normally-open. Accordingly, the controller may provide a command or electric signal to the solenoid coil 137 to restrict flow through the valve 300 or the valve 400.

At block 606, the method 600 includes, in response to receiving the electric signal, causing the armature 304 to apply a force on the push pin 145 in the distal direction.

At block 608, the method 600 includes causing the push pin 145 to apply a force on the second poppet 120, which is seated at the second seat 122 formed in the first poppet 116.

At block 610, the method 600 includes causing the first poppet 116 to move toward the first seat 118, thereby restricting fluid flow from the second port 114 to the first port 112.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” it is meant that the recited characteristic, parameter, or value need not be achieved exactly, but that deviations or variations, including for example, tolerances, measurement error, measurement accuracy limitations, friction between components, and other factors known to skill in the art, may occur in amounts that do not preclude the effect the characteristic was intended to provide

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

What is claimed is:

1. A valve comprising:
a main valve section comprising:
a housing,
a sleeve disposed in the housing,
a first poppet disposed in the sleeve and configured to move axially within the sleeve,
a second poppet disposed, at least partially, in the first poppet, wherein the second poppet is configured to move axially within the first poppet, and
a first spring that interfaces with the second poppet and applies a force on the second poppet in a proximal direction; and
a push-type solenoid actuator comprising:
a solenoid tube disposed partially within the housing of the main valve section,
an armature disposed within the solenoid tube,
a push pin disposed between the armature and the second poppet, and
a second spring disposed between the armature and the solenoid tube, thereby biasing the armature in a distal direction toward the push pin.

2. The valve of claim 1, wherein the armature includes a cavity defined at a proximal end of the armature, and wherein the second spring is disposed in the cavity between an interior proximal surface of the solenoid tube and an interior surface of the armature defining the cavity.

3. The valve of claim 1, further comprising:
a spring support member disposed in the housing; and
a retaining ring disposed about an exterior surface of the second poppet, wherein the first spring is disposed between the spring support member and the retaining ring.

4. The valve of claim 3, further comprising:
a third spring disposed about the exterior surface of the second poppet between a proximal end of the first poppet and the spring support member.

5. The valve of claim 4, wherein the push-type solenoid actuator further comprises:
a pole piece fixedly disposed adjacent to the armature in the solenoid tube, and wherein the valve further comprises:
a fourth spring disposed between the spring support member and the pole piece.

6. The valve of claim 5, wherein the pole piece defines a longitudinal channel therein, and wherein the push pin is disposed through the longitudinal channel.

7. The valve of claim 1, wherein the push-type solenoid actuator further comprises a solenoid coil disposed about an exterior surface of the solenoid tube.

8. The valve of claim 7, wherein the force applied by the first spring on the second poppet in the proximal direction is a first force, and wherein in response to energizing the solenoid coil, the armature applies a second force on the second poppet via the push pin in the distal direction.

9. The valve of claim 8, wherein the sleeve defines a first port and a second port, wherein the valve is normally-open such that, when the valve is in an unactuated state, fluid flow is allowed from the second port to the first port, wherein in response to energizing the solenoid coil and the second force overcoming the first force, the second poppet and the first poppet move axially to restrict flow from the second port to the first port.

10. The valve of claim 1, wherein the first spring has a first spring rate and the second spring has a second spring rate, wherein the second spring rate is smaller than the first spring rate.

11. The valve of claim 10, wherein the second spring rate is two orders of magnitude smaller than the first spring rate.

12. A valve comprising:
a sleeve defining a first longitudinal cylindrical cavity therein;
a first movable element disposed in the first longitudinal cylindrical cavity of the sleeve, wherein the first movable element is configured to move axially within the sleeve, and wherein the first movable element defines a second longitudinal cylindrical cavity therein;
a second movable element disposed, at least partially, in the second longitudinal cylindrical cavity of the first movable element, wherein the second movable element is configured to move axially within the first movable element;
a first spring that interfaces with the second movable element and applies a force on the second movable element in a proximal direction; and
an actuator comprising: (i) a tube, (ii) a plunger disposed within the tube, (iii) a push pin disposed between the plunger and the second movable element, and (iv) a second spring disposed between the plunger and the tube, thereby biasing the plunger in a distal direction toward the push pin.

13. The valve of claim 12, wherein the plunger includes a cavity defined at a proximal end of the plunger, and wherein the second spring is disposed in the cavity between an interior proximal surface of the tube and an interior surface of the plunger defining the cavity.

14. The valve of claim 12, further comprising:
a housing defining a third longitudinal cylindrical cavity therein, wherein the sleeve is disposed in the third longitudinal cylindrical cavity, and wherein the tube is disposed partially within the housing;
a spring support member disposed in the housing; and
a retaining ring disposed about an exterior surface of the second movable element, wherein the first spring is disposed between the spring support member and the retaining ring.

15. The valve of claim 14, further comprising:
a third spring disposed about the exterior surface of the second movable element between a proximal end of the first movable element and the spring support member;
a pole piece fixedly disposed adjacent to the plunger in the tube; and
a fourth spring disposed between the spring support member and the pole piece.

16. The valve of claim 12, wherein the first spring has a first spring rate and the second spring has a second spring rate, wherein the second spring rate is smaller than the first spring rate.

17. The valve of claim 16, wherein the second spring rate is two orders of magnitude smaller than the first spring rate.

18. A hydraulic system comprising:
a source of pressurized fluid;
a reservoir; and
a valve comprising:
a sleeve defining a first port fluidly coupled to the reservoir and a second port coupled to the source of pressurized fluid,
a first poppet disposed in the sleeve and configured to move axially within the sleeve, wherein the sleeve defines a seat on an interior surface of the sleeve, wherein the valve is normally-open such that, when the valve is in an unactuated state, the first poppet is unseated off the seat and fluid flow is allowed from the second port to the first port,
a second poppet disposed, at least partially, in the first poppet, wherein the second poppet is configured to move axially within the first poppet,
a first spring that interfaces with the second poppet and applies a force on the second poppet in a proximal direction, and
a push-type solenoid actuator comprising: (i) a solenoid tube, (ii) an armature disposed within the solenoid tube, (iii) a push pin disposed between the armature and the second poppet, and (iv) a second spring disposed between the armature and the solenoid tube, thereby biasing the armature in a distal direction toward the push pin.

19. The hydraulic system of claim 18, wherein the armature includes a cavity defined at a proximal end of the armature, and wherein the second spring is disposed in the cavity between an interior proximal surface of the solenoid tube and an interior surface of the armature.

20. The hydraulic system of claim 18, wherein the first spring has a first spring rate and the second spring has a second spring rate, wherein the second spring rate is smaller than the first spring rate.
